(19) United States
(12) Patent Application Publication
(10) Pub. No.: US 2024/0297319 A1
(43) Pub. Date: Sep. 5, 2024

(54) LARGE SITE FUEL CELL POWER SYSTEM INCLUDING HOT GAS DESULFURIZER AND METHOD OF OPERATING THEREOF

(71) Applicant: BLOOM ENERGY CORPORATION, San Jose, CA (US)

(72) Inventors: David WEINGAERTNER, Sunnyvale, CA (US); Srikanth RANGANATHAN, San Jose, CA (US)

(21) Appl. No.: 18/431,774

(22) Filed: Feb. 2, 2024

Related U.S. Application Data
(60) Provisional application No. 63/487,936, filed on Mar. 2, 2023.

(51) Int. Cl. H01M 8/0662; H01M 8/0612

(52) U.S. Cl. CPC H01M 8/0675; H01M 8/0618

(57) ABSTRACT

A system includes a desulfurizer vessel, a heat source configured to heat a fuel received from a fuel source to form a heated fuel, and a desulfurization catalyst located in the desulfurizer vessel and configured to catalytically adsorb sulfur species from the heated fuel and output a desulfurized fuel.

### FIELD

The present disclosure is directed generally to desulfurizer systems and specifically to large site fuel cell systems including a hot gas desulfurizer subsystem and method of operating thereof.

### BACKGROUND

Fuel cell stacks or columns of fuel cell systems are usually located in hot boxes (i.e., thermally insulated containers). The hot boxes of existing large stationary fuel cell systems are housed in cabinets, housings or enclosures. The terms cabinet, enclosure, and housing are used interchangeably herein. Fuel provided to fuel cell systems is typically desulfurized in a desulfurizer.

### SUMMARY

In one embodiment, a system includes a desulfurizer vessel, a heat source configured to heat a fuel received from a fuel source to form a heated fuel, and a desulfurization catalyst located in the desulfurizer vessel and configured to catalytically adsorb sulfur species from a heated fuel and output a desulfurized fuel.

In one embodiment, a method comprises providing a fuel inlet stream into a heat exchanger; heating the fuel inlet stream in the heat exchanger to generate a heated fuel stream; providing the heated fuel stream to a desulfurization catalyst; catalytically adsorbing sulfur species from the heated fuel on the desulfurization catalyst to generate a heated desulfurized fuel; providing the heated desulfurized fuel from the desulfurized catalyst into the heat exchanger to heat the fuel inlet stream; and providing a cooled desulfurized fuel from the heat exchanger.

### BRIEF DESCRIPTION OF THE DRAWINGS

FIG. 1 is a perspective view of a modular fuel cell fuel cell system 10, according to various embodiments of the present disclosure.

FIG. 2A is a perspective view of a large site fuel cell power system, FIG. 2B is a diagram of components of a gas and water distribution module of FIG. 2A, and FIG. 2C is a functional schematic of the system of FIG. 2A.

FIG. 3 is a schematic view of the central desulfurization system of FIGS. 2A and 2C.

### DETAILED DESCRIPTION

It is to be understood that both the foregoing general description and the following detailed description are exemplary and explanatory only, and are not restrictive of the invention as claimed.

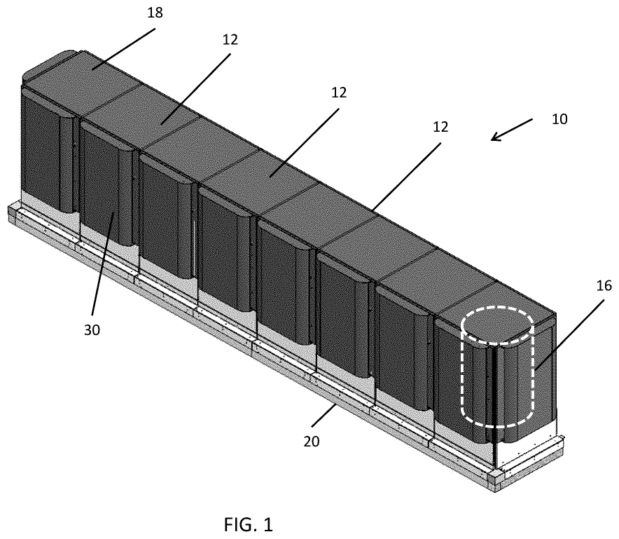

FIG. 1 is a perspective view of a modular fuel cell fuel cell system 10, according to various embodiments of the present disclosure. Referring to FIG. 1, the fuel cell system 10 may contain modules and components described in U.S. Pat. Nos. 9,190,693 and 9,755,263, which are incorporated herein by reference in their entireties. The modular design of the fuel cell system 10 provides flexible system installation and operation. Modules allow scaling of installed generating capacity, reliable generation of power, flexibility of fuel processing, and flexibility of power output voltages and frequencies with a single design set. The modular design results in an “always on” unit with very high availability and reliability. This design also provides an easy means of scale up to meet specific requirements of customer installations. The modular design also allows the use of available fuels and required voltages and frequencies which may vary by customer and/or by geographic region.

The modular fuel cell system 10 includes one or more fuel cell power modules 12 and one or more power conditioning (i.e., electrical output) modules 18. In embodiments, the power conditioning modules 18 are configured to deliver direct current (DC). In alternative embodiments, the power conditioning modules 18 are configured to deliver alternating current (AC). In these embodiments, the power conditioning modules 18 include a mechanism to convert DC to AC, such as an inverter. For example, the fuel cell system 10 may include any desired number of modules, such as 2-30 power modules, for example 3-12 power modules, such as 6-12 modules.

The fuel cell system 10 of FIG. 1 includes a row of seven power modules 12 and one power conditioning module 18 disposed on a pad 20. While one row of power modules 12 is shown, the fuel cell system 10 may comprise more than one row of modules 12. For example, the fuel cell system 10 may comprise two rows of power modules 12 arranged back to back/end to end.

Each power module 12 is configured to house one or more hot boxes 16. Each hot box 16 contains one or more stacks or columns of fuel cells (not shown for clarity), such as one or more stacks or columns of solid oxide fuel cells having a ceramic oxide electrolyte separated by conductive interconnect plates. Other fuel cell types, such as PEM, molten carbonate, phosphoric acid, etc. may also be used.

The fuel cell stacks may comprise externally and/or internally manifolded stacks. For example, the stacks may be internally manifolded for fuel and air with fuel and air risers extending through openings in the fuel cell layers and/or in the interconnect plates between the fuel cells.

Alternatively, the fuel cell stacks may be internally manifolded for fuel and externally manifolded for air, where only the fuel inlet and exhaust risers extend through openings in the fuel cell layers and/or in the interconnect plates between the fuel cells, as described in U.S. Pat. No. 7,713,649, which is incorporated herein by reference in its entirety. The fuel cells may have a cross flow (where air and fuel flow roughly perpendicular to each other on opposite sides of the electrolyte in each fuel cell), counter flow parallel (where air and fuel flow roughly parallel to each other but in opposite directions on opposite sides of the electrolyte in each fuel cell) or co-flow parallel (where air and fuel flow roughly parallel to each other in the same direction on opposite sides of the electrolyte in each fuel cell) configuration.

The power conditioning module 18 includes components for converting the fuel cell stack generated DC power to AC power (e.g., DC/DC and DC/AC converters described in U.S. Pat. No. 7,705,490, incorporated herein by reference in its entirety), electrical connectors for AC power output to the grid, circuits for managing electrical transients, a system controller (e.g., a computer or dedicated control logic device or circuit). The power conditioning module 18 may be designed to convert DC power from the fuel cell modules to different AC voltages and frequencies. Designs for 208V, 60 Hz; 480V, 60 Hz; 415V, 50 Hz and other common voltages and frequencies may be provided.

The linear array of power modules 12 is readily scaled. For example, more or fewer power modules 12 may be provided depending on the power needs of the building or other facility serviced by the fuel cell system 10. The power modules 12 and input/output modules may also be provided in other ratios. For example, in other exemplary embodiments, more or fewer power modules 12 may be provided.

The modular fuel cell system 10 may be configured in a way to ease servicing of the components of the fuel cell system 10. For example, the fuel cell system 10 may include access doors 30. All of the routinely or high serviced components (such as the consumable components) may be placed in a single module to reduce amount of time required for the service person.

For example, when one power module 12 is taken offline (i.e., no power is generated by the stacks in the hot box 16 in the offline module 12), the remaining power modules 12 and the power conditioning module 18 are not taken offline. Furthermore, the fuel cell system 10 may contain more than one of each type of module 12, 18. When at least one module of a particular type is taken offline, the remaining modules of the same type are not taken offline.

Thus, in a system comprising a plurality of modules, each of the modules 12 or 18 may be electrically disconnected, removed from the fuel cell system 10 and/or serviced or repaired without stopping an operation of the other modules in the system, allowing the fuel cell system to continue to generate electricity. The entire fuel cell system 10 does not have to be shut down if one stack of fuel cells in one hot box 16 malfunctions or is taken offline for servicing.

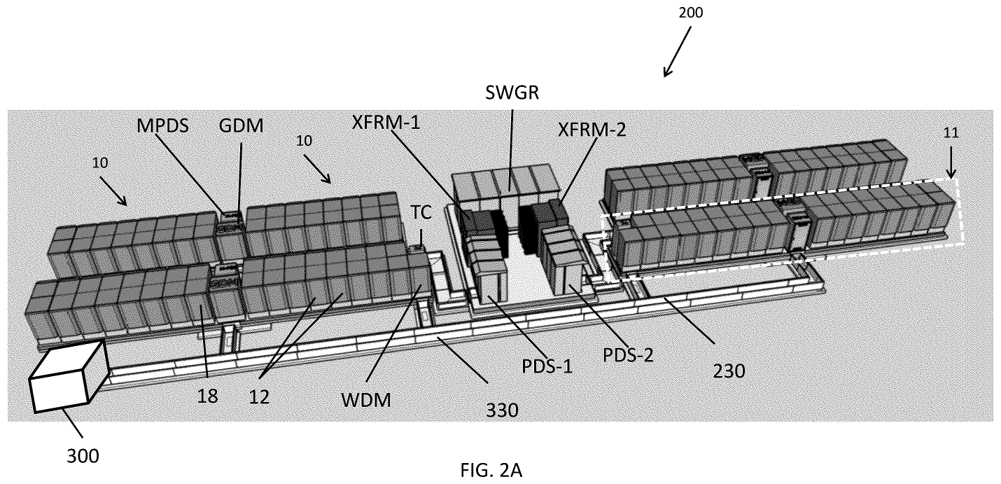

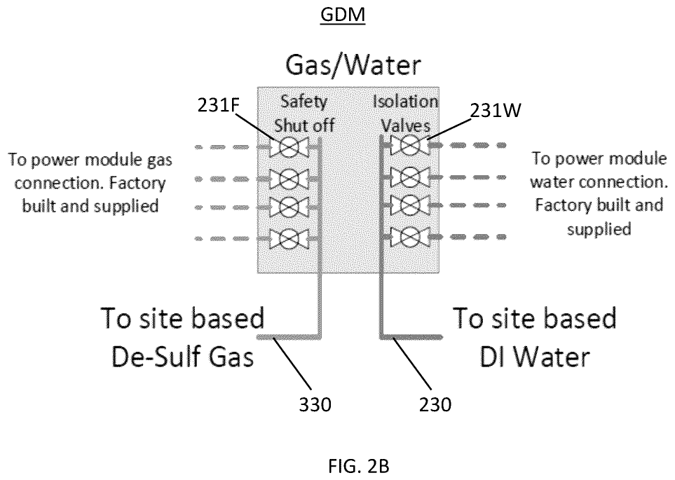

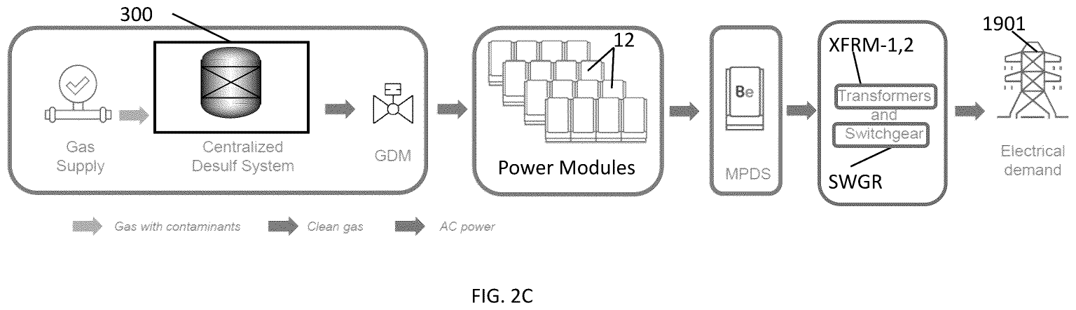

FIG. 2A is a perspective view of the large site fuel cell power system 200. FIG. 2B is a diagram of components of a gas and water distribution module of FIG. 2A. FIG. 2C is a functional schematic of the system 200. All modules described below may be located in a separate housing from the other modules. The system 200 reduces the number of components, and simplifies component installation, thus reducing the total system cost.

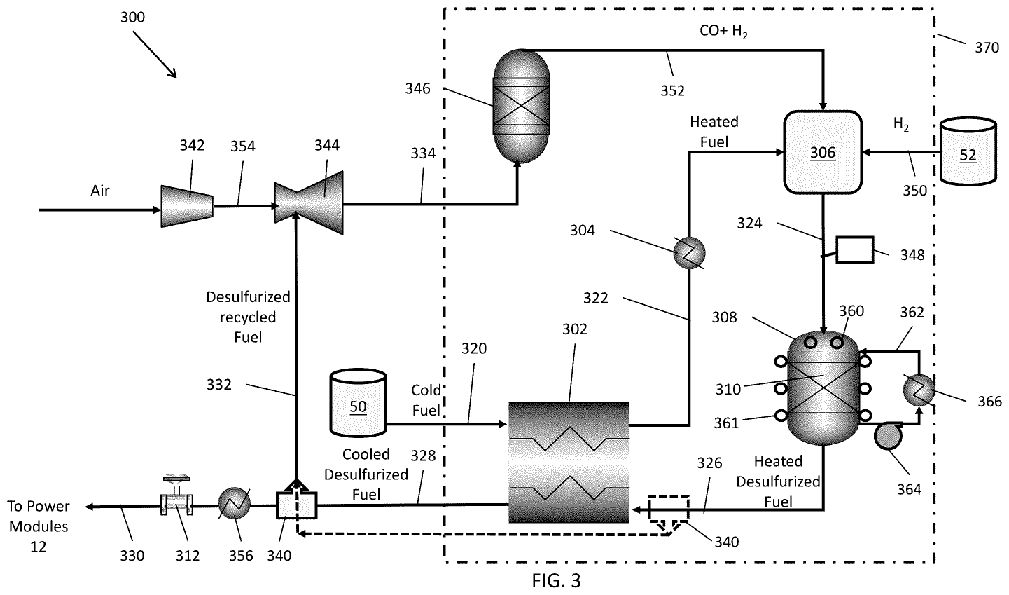

Referring to FIG. 2A, the large site fuel cell power system 200 contains multiple of the above described power unit fuel cell systems 10. In some embodiments, the fuel cell power system 200 may be configured to generate at least 2 MW of AC power. A single gas and water distribution module (GDM) is fluidly connected to multiple fuel cell systems 10. For example, at least two fuel cell systems 10 each, such as four rows of seven power modules each, are fluidly connected to a single gas and water distribution module (GDM). As shown in FIG. 2B, the gas and water distribution module GDM may include connections between water plumbing 230 and fuel plumbing 330 and the power modules 12. The connections may include conduits (e.g., pipes) and valves 231F and 231W which route the respective fuel and water from the central plumbing 330, 230 into each power module. The water plumbing 230 may be connected to a municipal water supply pipe. A single system level fuel processing system, such as a desulfurizer system 300 which is discussed in detail below with respect to FIG. 3, includes components for pre-processing of fuel, such as one or more desulfurizers and/or other impurity adsorption components, may be connected to all gas plumbing (i.e., gas conduit) 330. Thus, a single desulfurizer system 300 may be used to desulfurize natural gas fuel provided to all GDMs in the fuel cell system 200. The fuel may be provided to the desulfurizer system from a fuel utility (e.g., natural gas utility) or from another source (e.g., one or more fuel storage vessels).

Optionally one or more water distribution modules (WDM) may be provided in the system. The WDM may include water treatment components (e.g., water deionizers) and water distribution pipes and valves which are connected to the municipal water supply pipe, and to the individual modules in the system.

Each fuel cell system 10 is electrically connected to a single power conditioning module 18, which may include a DC to AC inverter and other electrical components. A single mini power distribution module (MPDS) is electrically to each of the power conditioning modules 18. For example, at least two rows of at least six power modules 12 each, such as four rows of seven power modules each, are electrically connected to a single MPDS through the respective power conditioning modules 18, such as four power conditioning modules 18. Thus, four inverters in power conditioning modules 18 and telemetry (e.g., data) cables may be connected to the single MPDS. The MPDS may include circuit breakers and electrical connections between the plural power conditioning modules 18 and one of the system power distribution modules PDS-1 or PDS-2.

One or more telemetry modules (TC) may also be included in the system. The telemetry modules may include system controllers and communication equipment which allows the system to communicate with the central controller and system operators. Each telemetry module may be connected to a respective MPDS via a telemetry data cable (e.g., a Cat 5 cable). The system also includes the system power distribution unit (i.e., central power supply unit) that powers a telemetry ethernet switch (4:1). The system power distribution unit may also feed the safety systems within the GDMs to reduce the number of power conduits and telemetry conduits installed by an onsite contractor from 4 into 1. Alternatively, each telemetry module (TC) may include a wireless transceiver unit for data communications between the telemetry module TC and either the power conditioning modules 18 and/or the MPDS. This eliminates the data cable installation.

Multiple fuel cell systems 10 that are fluidly and electrically connected to the same GDM and the same MPDS, respectively, may be referred to as a subsystem 11. The fuel cell power system 200 may include plural subsystems 11, such as two to ten subsystems. Four subsystems 11 are shown in FIG. 2A.

The fuel cell system may also include a system power distribution unit which is electrically connected to all subsystems of the fuel cell system. The system power distribution unit may include at least one system power distribution module, such as two modules PDS-1 and PDS-2, at least one transformer, such as two transformers (XFMR-1 and XFMR-2) and a disconnect switch gear (SWGR). The transformers XFMR-1 and XFMR-2 may be electrically connected to the respective PDS-1 and PDS-2 modules. The switch gear may comprise 15 kV switch gear which has inputs electrically connected to the transformers and an output electrically connected to an electrical load and/or grid. An optional uninterruptible power subsystem (UPS) may also be included. Thus, electric power is provided from the power modules through the respective MPDS, PDS-1 or PDS-1, XFMR-1 or XFMR-2 and SWGR to the grid and/or load.

As shown in FIG. 2C, a central desulfurization system (e.g., module) 300 is used in place of conventional separate desulfurizers in each row of power modules. The central desulfurization system 300 is fluidly connected to each GDM, which is fluidly connected to the power modules 12 to provide fuel to the power modules 12. Alternatively, there may be plural central desulfurization systems 300, each of which is fluidly connected to a subset of all GDMs. The power modules 12 are electrically connected to the MPDS, which is electrically connected to the electrical load (e.g., the power grid or a stand-alone load) 1901. The schematic of the components of the central desulfurization system 300 is shown in FIG. 3.

FIG. 3 is a schematic view of desulfurization system. In one embodiment, the desulfurization system illustrated in FIG. 3 may comprise a local desulfurization system located in a module in the row of modules of each fuel cell system 10 together with the power modules 12 and the power conditioning modules 18. In another embodiment, the desulfurization system of FIG. 3 comprises the central desulfurization system 300 of FIGS. 2A and 2C.

Referring to FIG. 3, the central desulfurization system 300 may include a desulfurizer vessel 308 containing a desulfurization catalyst 310. In one embodiment, the desulfurizer vessel 308 comprises a pressure vessel configured to operate at a pressure above 1 atmosphere. The catalyst 310 may comprise any suitable desulfurization catalyst. For example, the catalyst 310 may be an adsorptive desulfurization catalyst configured to convert sulfur species that may be found in a fuel (e.g., natural gas, methane, or biogas), into adsorbable sulfur compounds. For example, the catalyst 310 may be configured to catalyze a reaction between hydrogen (H₂) and sulfur species, such as dimethyl sulfide, dimethyl disulfide, carbon oxysulfide (COS), and/or carbon disulfide (CS₂), to generate hydrogen sulfide. The hydrogen sulfide may be adsorbed by the catalyst 310 and/or sequestered within the desulfurizer vessel 308. In some embodiments, the catalyst 310 may comprise two separate catalysts, one of which generates hydrogen sulfide and the other one of which captures (e.g., adsorbs) the hydrogen sulfide. In some embodiments, the catalyst 310 may be configured to adsorb all or substantially all sulfur impurities that may be present in the fuel, and output desulfurized gas having a sulfur content of about 10 ppb or less, such as about 5 ppb or less, such as 0 to 5 ppb.

In some embodiments, the catalyst 310 may include a metal or metal alloy catalyst supported on a substrate material, such as a ceramic substrate. The catalyst 310 metal may comprise a precious metal, such as Pt, Pd, Rh, Ru, Au, etc., and/or a non-precious metal or non-precious metal oxide, nonprecious metal sulfide, or nonprecious metal carbonate, such as Ni, Cu, Mn, Al, Fe, Co, Mo and/or Zn. For example, hydrodesulfurization catalysts may comprise cobalt molybdenum alloys or molybdenum sulfide. Hydrolysis catalysts may comprise alumina based catalysts. Adsoprtion catalysts may comprise zinc oxide or other suitable catalysts.

In one embodiment, the catalyst 310 may comprise a catalyst which operates above ambient temperature, e.g., above 40° C. In one embodiment, the catalyst 310 is a high temperature catalyst and may be configured to operate at a temperature ranging from about 200° C. to about 300° C. Alternatively, the catalyst 310 is an intermediate temperature catalyst and may be configured to operate at a temperature ranging from about 120° C. to about 150° C. Alternatively, the catalyst 310 is a medium temperature catalyst and may be configured to operate at a temperature ranging from about 50° C. to about 100° C. The catalyst 310 may be configured to operate an elevated pressure ranging from about 20 to 100 psig, such as 40 to 50 psig, or at low pressure (i.e., 15 psig).

In one embodiment, the catalyst 310 comprises a hydrodesulfurization catalyst which uses hydrogen in the fuel stream to generate the sulfur containing species which are adsorbed to the catalyst. Alternatively or additionally, the catalyst 310 comprises a hydrolysis catalyst which uses the water in the fuel stream to generate the sulfur containing species which are adsorbed to the catalyst. In another embodiment, the hydrodesulfurization catalyst may be mixed with an adsorption catalyst, or the hydrolysis catalyst may be mixed with or followed by an adsorption catalyst. In this embodiment, the adsorption catalyst is located downstream of the hydrolysis catalyst. The hydrodesulfurization catalyst or the hydrolysis catalyst catalytically converts mercaptan or sulfide molecules into H₂S molecules, which are then adsorbed onto the adsorption catalyst. If the fuel from the fuel source 50 comprises liquified natural gas, then additional water may be added to the fuel if a hydrolysis catalyst 310 is used. The water may be added from an external water source, from the CPOx reactor 346 and/or from an electrolyzer hydrogen source 52, which are described below.

The desulfurization system 300 may include a heat exchanger 302 and a cold fuel conduit 320 that fluidly connects a first inlet of the heat exchanger 302 to a fuel source 50, such as a natural gas conduit (e.g., a natural gas utility line) or tank. Other fuel sources (e.g., a natural gas, methane or biogas storage vessel, a biogas reactor, etc.) may also be used. A first outlet of the heat exchanger 302 may be fluidly connected to an inlet of an optional mixer 306 by a heated fuel conduit 322. An outlet of the mixer 306 may be fluidly connected to an inlet of the desulfurizer vessel 308 by a mixed fuel conduit 324. An outlet of the desulfurizer vessel 308 may be fluidly connected to a second inlet of the heat exchanger 302 by a heated desulfurized fuel conduit 326. A second outlet of the heat exchanger 302 may be fluidly connected to a pressure regulator 312 by a cooled desulfurized fuel conduit 328. The cooled desulfurized fuel conduit 328 provides the cooled desulfurized fuel from the heat exchanger to the GDM or directly to the power modules 12 of one or more of the fuel cell systems 10 via the above described fuel plumbing 330.

In operation, the cold fuel inlet stream provided from the fuel source 50 at ambient temperature or at an elevated temperature may be heated in the heat exchanger 302 by extracting heat from the heated desulfurized fuel output from the desulfurizer vessel 308. In some embodiments, the desulfurizer system 300 may include a trim heater 304 on the heated fuel conduit 322 configured to heat the heated fuel output from the heat exchanger 302 to fuel conduit 322 if the heat content of the heated desulfurized fuel is insufficient to heat the cold fuel inlet stream to a desired operating temperature of the catalyst 310. For example, the trim heater 304 may be a gas heater or an electric heater. The heated fuel may be at a temperature of 170 to 225 degrees Celsius in the heated fuel conduit 322.

If the catalyst 310 comprises a hydrodesulfurization catalyst, then the catalyst uses hydrogen in the desulfurization process. In this embodiment, if the fuel inlet stream provided from the fuel source 50 contains an amount of hydrogen gas that is sufficient for operation of the catalyst 310, then no additional hydrogen is added to the fuel provided to the desulfurizer vessel 308 during start-up or steady-state operation. For example, if the fuel inlet stream contains 2 to 3 volume percent hydrogen gas (i.e., free H₂), then hydrogen may not have to be added to the fuel inlet stream.

Alternatively, if the fuel inlet stream provided from the fuel source 50 contains an amount of hydrogen gas that is insufficient for operation of the catalyst 310, the system 300 may optionally comprise a hydrogen (H₂) source configured to increase the hydrogen content of the fuel. For example, in some embodiments, system 300 may optionally include a hydrogen source 52 that is fluidly connected to the mixer 306 by an optional hydrogen conduit 350. The hydrogen source 52 may supply hydrogen to the mixer 306, where the hydrogen may be mixed with the heated fuel prior to the heated fuel being supplied to the desulfurizer vessel 308. For example, the hydrogen source 52 may be a hydrogen tank, an electrolyzer or a reformer configured to supply and/or generate an amount of hydrogen sufficient to insure proper operation of the desulfurization catalyst 310. If the hydrogen source 52 comprises an electrolyzer, then it may electrochemically convert water into hydrogen and oxygen using an electrolysis reaction, and provide the hydrogen to the mixer 306.

The mixer 306 outputs a mixed fuel stream into the mixed fuel conduit 324. The mixed fuel stream includes at least the heated fuel stream from the heated fuel conduit 322 and optionally hydrogen (e.g., from the hydrogen conduit 350 and/or from conduit 352 described below). The mixed fuel may be provided at a temperature of 200 to 250 degrees Celsius from the mixed fuel conduit 324 to the desulfurizer vessel 308.

In other embodiments, the system 300 may optionally include a splitter 340, an air compressor 342, a fuel compression device 344, and a catalytic partial oxidation (CPOx) reactor 346, to generate hydrogen gas for the fuel. An optional air filter may be provided upstream of the air compressor 342. In one embodiment, the splitter 340 may located on the cooled desulfurized fuel conduit 328, as shown by the solid lines in FIG. 3. In an alternative embodiment, the splitter 340 may be located on the heated desulfurized fuel conduit 326 between the desulfurizer vessel 308 and heat exchanger 302, as shown by the dashed lines in FIG. 3. In both embodiments, the splitter 340 may be fluidly connected to an inlet of the fuel compression device 344 by a fuel recycle conduit 332. The fuel compression device 344 may be a Venturi device and/or a fuel blower or compressor.

The air compressor 342 may be fluidly connected to an inlet of the fuel compression device 344 by an air conduit 354. An outlet of the fuel compression device 344 may be fluidly connected to an inlet of the CPOx reactor by a mixed fuel conduit 334. An outlet of the CPOx reactor 346 may be fluidly connected to an inlet of the mixer 306 by a hydrogen mixture conduit 352.

In operation, the splitter 340 may divert a portion of the desulfurized fuel from either one of the desulfurized fuel conduits 326 or 328 to the fuel compression device 344 via the fuel recycle conduit 332, and the air compressor 342 may provide compressed air to the fuel compression device 344 via the air conduit 354. A pressurized fuel and air mixture may be provided from the fuel compression device 344 to the CPOx reactor 346 via the mixed fuel conduit 334. An air flow rate of the air compressor 342 may be set by controlling an operating speed of the air compressor 342, in order to maintain a consistent temperature within or at the exit of the CPOx reactor 346. If the fuel compression device 344 comprises the venturi, then the pressurized air flowing from the converging inlet part of the venturi into the throat of the venturi draws the cooled desulfurized fuel from the fuel recycle conduit 332 into the throat of the venturi. The pressurized fuel and air mixture is then provided from throat of the venturi to the diverging output part of the venturi, and then to the CPOx reactor 346 via the mixed fuel conduit 334. If the fuel compression device 344 comprises a fuel blower or compressor, then it may be located on the fuel recycle conduit 332, and its output may be provided into a supplemental mixer located at the junction of the fuel recycle conduit 332 and the air conduit 354. By providing desulfurized fuel to CPOx reactor 346, the CPOx reactor catalyst does not need to be sulfur tolerant.

The CPOx reactor 346 may be configured to partially oxidize the fuel and generate a mixture of hydrogen and carbon monoxide (i.e., oxidized recycled fuel) that may be supplied to the mixer 306 to increase the hydrogen content of the heated fuel provided to the desulfurizer vessel 308, and thereby insure proper operation of the desulfurization catalyst 310. In some embodiments, the amount of hydrogen generated by the CPOx reactor 346 may be controlled by controlling the amount of the cooled desulfurized fuel that is diverted by the splitter 340.

During a start-up mode, if the desulfurization catalyst 310 sufficiently desulfurizes the fuel inlet stream at ambient temperature, then the recycled desulfurized fuel stream may be provided to the CPOx reactor 346 via conduits 332 and 334. Alternatively, if the desulfurization catalyst 310 does not sufficiently desulfurize the fuel inlet stream during the start-up mode, then the CPOx reactor 346 may be operated on sulfur free natural gas stream during the start-up mode. Alternatively, a low temperature sulfur adsorption bed may be added on conduit 332 and/or 334 upstream of the CPOx reactor 346 to adsorb the breakthrough sulfur in the recycled fuel stream during the start-up mode.

In alternative embodiments, if the fuel source 50 provides a hydrogen containing fuel, then the CPOx reactor 346 and/or the hydrogen source 52 may be omitted. For example, if the fuel source 50 comprises a natural gas line from a natural gas utility which adds hydrogen to the natural gas fuel, then the CPOx reactor 346 and/or the hydrogen source 52 may be omitted, and the hydrogen for the hydrodesulfurization catalyst 310 is provided from the fuel source 50.

In some embodiments, if the desulfurization catalyst 310 becomes saturated with adsorbed sulfur, the desulfurization catalyst 310 may be removed from the desulfurizer vessel 308, regenerated to remove the adsorbed sulfur, and returned to the desulfurizer vessel 308. In one embodiment, the system 300 may include multiple desulfurizer vessels 308 and desulfurization catalysts 310, which may be fluidly connected in parallel. In such embodiments, one desulfurization vessel 308 is in operation, while another desulfurization vessel is taken offline to either replace or regenerate the catalyst 310 to remove the desorbed sulfur species. In another embodiment, the system 300 may include plural desulfurizer units 370. While one desulfurizer unit is operating, another desulfurizer unit may be taken offline for replacement or regeneration of the catalyst 310. In this embodiment, each desulfurizer unit 370 includes a separate heat exchanger 302, optional trim heater 304, desulfurizer vessel 308, and CPOx reactor 346. Valves may be placed on conduits 320, 328, 334 and 350 to switch the fluid flows between the desulfurizer units 370, depending on which unit is operating.

In various embodiments, the vessel 308 may include an optional heater, such as an internal heater 360 and/or an external heater 361 configured to heat the fuel and/or catalyst 310 to a desired desulfurization temperature. The internal heater 360 may be located above the catalyst 310 bed(s) in the vessel 308 to preheat the fuel before it reaches the catalyst 310. The external heater 361 may be located on the outside wall of the vessel 308. The heaters 360 and/or 361 may comprise resistance (i.e., electric) heaters, fuel fired heaters, one or more conduits which circulate a hot heat transfer fluid, or any other suitable heaters. Such a heater may be selectively operated, such as during system startup, and optionally during steady-state operation. Alternatively, if the vessel 310 does not include such a heater, the system 300 may optionally include a recirculation conduit 362, a high temperature blower 364, and a startup heater 366 configured to heat and continuously recirculate gas through the desulfurizer vessel 308 during system startup. The recirculation gas for startup may be H₂, N₂, CH₄, and/or natural gas, for example.

In some embodiments, the system 300 may optionally include a gas analyzer 348 configured to monitor the hydrogen content of the fuel provided to the desulfurizer vessel 308. Alternatively, the hydrogen content may be calculated based on flow rates of the fuel inlet stream from the fuel source 50 and/of a flow rate of the recycled desulfurized fuel from the splitter 340.

The system 300 may also include a fuel cooler 356 located on the cooled desulfurized fuel conduit 328 configured to cool the desulfurized fuel to a desired temperature for fuel to be provided to the power modules. For example, the fuel cooler 356 may be an air cooler (i.e., portion of conduit 328 exposed to ambient air) configured to reduce the temperature of the desulfurized fuel in conduit 330 to a temperature ranging from about 35° C. to about 45° C. to protect components of the GDM and/or the power modules 12.

In one embodiment, a system 300 comprises the desulfurizer vessel 308 and the desulfurization catalyst 310 located in the desulfurizer vessel 308. The desulfurization catalyst 310 is configured to catalytically adsorb sulfur species from the heated fuel (e.g., the fuel stream from the mixed fuel conduit 324) and to output a desulfurized fuel (e.g., the heated desulfurized fuel stream into the heated desulfurized fuel conduit 326). The system 300 also comprises a heat source configured to heat a fuel from a fuel source to form the heated fuel.

In one embodiment, the heat source comprises the heat exchanger 302 configured to heat the fuel inlet stream received from the fuel source 50 by extracting heat from the desulfurized fuel (e.g., the heated desulfurized fuel stream) output from the desulfurizer vessel 308 and to provide the heated fuel (e.g., the heated fuel stream) to the desulfurizer vessel 308. In another embodiment, the heat source comprises one or more of the above described heaters 304, 360, 361 and/or 366 in addition to or instead of the heat exchanger 302. In yet another embodiment, the heat source comprises the CPOx reactor 346 instead of or in addition to the heat exchanger 302 and/or heaters 304, 360, 361 and/or 366.

In one embodiment, the desulfurization catalyst 310 comprises an adsorptive desulfurization catalyst configured to catalytically adsorb the sulfur species from the fuel at a temperature ranging from about 200° C. to about 300° C. and at a pressure ranging from about 20 to about 100 psig.

In one embodiment, the desulfurization catalyst 310 comprises a hydrodesulfurization catalyst. In this embodiment, the system 300 further comprises the hydrogen source (52, 346) and the mixer configured to mix heated fuel received from the heat exchanger 302 with hydrogen (H₂) received (e.g., via the hydrogen conduit 350) from the hydrogen source 52 and to provide the heated fuel mixed with hydrogen (e.g., via the mixed fuel conduit 324) to the desulfurizer vessel 308. In one embodiment, the hydrogen source 52 comprises a hydrogen tank or an electrolyzer.

In another embodiment, the hydrogen source 346 comprises a catalytic partial oxidation (CPOx) reactor. In this embodiment, the system 300 further comprises the splitter 340 configured to divert a portion of the desulfurized fuel (e.g., the portion of the cooled desulfurized steam flowing through the cooled desulfurized conduit 328) output from the desulfurizer vessel 308, an air compressor 342, and a fuel compression device 344 configured to receive compressed air from the air compressor 342 and the desulfurized fuel from the splitter 340, and to output a pressurized fuel and air mixture to the CPOx reactor 346.

In one embodiment, the system (e.g., system 200 which includes the system 300) further comprises at least one fuel cell system 10 configured to receive at least a portion of the desulfurized fuel output from the desulfurizer vessel 308 (or desulfurizer unit 370). In one embodiment, the at least one fuel cell system 10 comprises a plurality of fuel cell systems 10, and each of the fuel cell systems 10 comprises fuel cell power modules 12 and a power conditioning module 18 electrically connected to the power modules 12.

In one embodiment, a method comprises providing a fuel inlet stream into a heat exchanger 302; heating the fuel inlet stream in the heat exchanger to generate a heated fuel stream; providing the heated fuel stream to a desulfurization catalyst 310; catalytically adsorbing sulfur species from the heated fuel on the desulfurization catalyst 310 to generate a heated desulfurized fuel; providing the heated desulfurized fuel from the desulfurized catalyst 310 into the heat exchanger 302 to heat the fuel inlet stream; and providing a cooled desulfurized fuel from the heat exchanger 302.

In one embodiment, the method further comprises providing the cooled desulfurized fuel from the heat exchanger 302 into at least one fuel cell system 10.

In one embodiment, the desulfurization catalyst 310 comprises a hydrodesulfurization catalyst, and the method further comprises providing hydrogen from a hydrogen source (52, 346) into the heated fuel stream after the heating the fuel inlet stream in the heat exchanger 302 to generate the heated fuel stream and before providing the heated fuel stream to the desulfurization catalyst 310. As described above, the hydrogen source 52 may comprise a hydrogen tank or an electrolyzer. Alternatively, the hydrogen source 346 comprises a catalytic partial oxidation (CPOx) reactor. In this embodiment, the method further comprises diverting a portion of the cooled desulfurized fuel into a fuel compression device 344 to generate a pressurized desulfurized fuel; providing a mixture of air and the pressurized desulfurized fuel to the CPOx reactor 346; generating a mixture of the hydrogen and carbon monoxide in the CPOx reactor 346; and providing a mixture of the hydrogen and carbon monoxide into the heated fuel stream.

The embodiments of the present disclosure provide an elevated temperature desulfurizer system 300 in which the fuel inlet stream is preheated in a heat exchanger by the desulfurized fuel stream exiting the desulfurizer vessel. This decreases the cost of operating the system by reducing the amount of heat that is provided by various heaters and/or by eliminating the external heaters. The fuel cell systems of the embodiments of the present disclosure are designed to reduce greenhouse gas emissions and have a positive impact on the climate.

The arrangements of the fuel cell systems, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein.

Some elements shown as integrally formed may be constructed of multiple parts or elements, the position of elements may be reversed or otherwise varied, and the nature or number of discrete elements or positions may be altered or varied. Other substitutions, modifications, changes and omissions may also be made in the design, operating conditions and arrangement of the various exemplary embodiments without departing from the scope of the present disclosure. Any one or more features of any embodiment may be used in any combination with any one or more other features of one or more other embodiments.

1. A system, comprising
a desulfurizer vessel;
a heat source configured to heat a fuel received from a fuel source to form a heated fuel; and
a desulfurization catalyst located in the desulfurizer vessel and configured to catalytically adsorb sulfur species from the heated fuel and output a desulfurized fuel.

2. The system of claim 1, wherein the desulfurization catalyst comprises an adsorptive desulfurization catalyst configured to catalytically adsorb the sulfur species from the fuel at a temperature above 40° C.

3. The system of claim 1, wherein the desulfurization catalyst comprises a hydrodesulfurization catalyst.

4. The system of claim 3, wherein the desulfurization catalyst further comprises an adsorptive catalyst located downstream from the hydrodesulfurization catalyst.

5. The system of claim 3, further comprising:
a hydrogen source; and
a mixer configured to mix heated fuel received from the heat source with hydrogen (H₂) received from the hydrogen source and to provide the heated fuel mixed with hydrogen to the desulfurizer vessel.

6. The system of claim 4, wherein the hydrogen source comprises a hydrogen tank or an electrolyzer.

7. The system of claim 3, wherein the heat source and the hydrogen source comprise a catalytic partial oxidation (CPOx) reactor.

8. The system of claim 7, further comprising:
a splitter configured to divert a portion of the desulfurized fuel output from the desulfurizer vessel;
an air compressor; and
a fuel compression device configured to receive compressed air from the air compressor and the desulfurized fuel from the splitter, and to output a pressurized fuel and air mixture to the CPOx reactor.

9. The system of claim 1, wherein the heat source comprises:
at least one of a catalytic partial oxidation (CPOx) reactor or a heater; and
a heat exchanger configured to heat the fuel received from the fuel source by extracting heat from the desulfurized fuel output from the desulfurizer vessel and to provide the heated fuel to the desulfurizer vessel.

10. The system of claim 1, wherein the heat source comprises a heater.

11. The system of claim 1, further comprising at least one fuel cell system configured to receive at least a portion of the desulfurized fuel output from the desulfurizer vessel.

12. The system of claim 11, wherein the at least one fuel cell system comprises a plurality of fuel cell systems, and wherein each of the fuel cell systems comprises fuel cell power modules and a power conditioning module electrically connected to the power modules.

13. A method, comprising:
providing a fuel inlet stream into a heat exchanger;
heating the fuel inlet stream in the heat exchanger to generate a heated fuel stream;
providing the heated fuel stream to a desulfurization catalyst;
catalytically adsorbing sulfur species from the heated fuel on the desulfurization catalyst to generate a heated desulfurized fuel;
providing the heated desulfurized fuel from the desulfurized catalyst into the heat exchanger to heat the fuel inlet stream; and
providing a cooled desulfurized fuel from the heat exchanger.

14. The method of claim 13, wherein the desulfurization catalyst comprises an adsorptive desulfurization catalyst which catalytically adsorbs the sulfur species from the fuel at a temperature above 40° C.

15. The method of claim 13, wherein the desulfurization catalyst comprises a hydrodesulfurization catalyst.

16. The method of claim 15, further comprising providing hydrogen from a hydrogen source into the heated fuel stream after the heating the fuel inlet stream in the heat exchanger to generate the heated fuel stream and before providing the heated fuel stream to the desulfurization catalyst.

17. The method of claim 16, wherein the hydrogen source comprises a hydrogen tank or an electrolyzer.

18. The method of claim 16, wherein the hydrogen source comprises a catalytic partial oxidation (CPOx) reactor.

19. The method of claim 18, further comprising:
diverting a portion of the cooled desulfurized fuel into a fuel compression device to generate a pressurized desulfurized fuel;
providing a mixture of air and the pressurized desulfurized fuel to the CPOx reactor;
generating a mixture of the hydrogen and carbon monoxide in the CPOx reactor; and
providing a mixture of the hydrogen and carbon monoxide into the heated fuel stream.

20. The method of claim 13, further comprising providing the cooled desulfurized fuel from the heat exchanger into a plurality of fuel cell systems, wherein each of the fuel cell systems comprises fuel cell power modules and a power conditioning module electrically connected to the power modules.
